(19) United States
(12) Patent Application Publication
(10) Pub. No.: US 2010/0241677 A1
(43) Pub. Date: Sep. 23, 2010

(54) MEMORY DEVICE AND FILE SYSTEM

(75) Inventors: Takashi Oshima, Chiba (JP); Chikara Kondo, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/676,740

(22) PCT Filed: Sep. 3, 2008
(86) PCT No.: PCT/JP2008/066265

§ 371 Date: Mar. 5, 2010

(30) Foreign Application Priority Data
Sep. 6, 2007 (JP) 2007-231819

(51) Int. Cl. G06F 17/30; G06F 12/00; G06F 12/16

(52) U.S. Cl. 707/824; 711/162; 711/103; 707/E17.01; 711/E12.001; 711/E12.103; 711/E12.008

(57) ABSTRACT

In response to an instruction to read/write data from a host device 2 employing a FAT file system that uses multiplexed file management information including a FAT 5a and a FAT 5b as backup information, a controller 11 that constitutes a memory system 1 including a NAND flash memory 12 as a non-volatile area uses a FAT 18 as file management information that does not include the backup information to handle the reading/writing of data.

### TECHNICAL FIELD

The present invention relates to a memory device and a file system that reduce consumption and the like of a memory area when managing files.

### BACKGROUND ART

In a conventional memory device, a memory system 51 configured as shown in FIG. 6 is generally used. The memory system 51 includes a controller 52 that exchanges a protocol with a host device connected through a bus and a non-volatile storage area 53 that holds data.

If the memory system 51 is a FAT file system based on, for example, a FAT (file allocation table), the non-volatile storage area 53 stores user data such as photographs and files, FAT file system data for managing file information of the user data, management information data for management and operation by the controller 52, and the like. Therefore, the memory system 51 needs a non-volatile storage area 53 in which the storage capacity is greater than the values.

FIG. 7 depicts an operation of the conventional FAT file system including a host device 54. In the conventional FAT file system, the host device 54 includes a plurality of the same information for managing data as files (hereinafter referred to as file management information) to be read from and written to the memory system 51. Thus, the host device 54 is designed to multiplex and hold the file management information.

Therefore, as shown in FIG. 7, the host device 54 includes a host-side first FAT 55a as file management information and a host-side second FAT 55b as backup (copy) information of the host-side first FAT 55a. Obviously, the data of the host-side second FAT 55b and the data of the host-side first FAT 55a are the same data.

In this way, the host device 54 instructs the memory system 51 to read/write data in accordance with the multiplexed file management information of the host-side first FAT 55a and the host-side second FAT 55b.

Accordingly, the controller 52 of the memory system 51 creates, in the non-volatile storage area 53, a memory-side first FAT 56a and a memory-side second FAT 56b as file management information respectively corresponding to the host-side first FAT 55a and the host-side second FAT 55b.

In the conventional example, the memory-side first FAT 56a and the memory-side second FAT 56b account for most of the FAT file system area.

The memory-side first FAT 56a and the memory-side second FAT 56b are frequently read/written (referred/rewritten) from the host device 54 side and are often managed by the controller 52 using a cache or the like to attain high speed.

Therefore, the memory-side first FAT 56a and the memory-side second FAT 56b often consume more non-volatile storage area 53 than the user data having the same size as data of only the original memory-side first FAT 56a and the memory-side second FAT 56b.

An available non-volatile storage area needs to be always kept as a margin for the controller 52 to operate when the non-volatile storage area 53 is formed by a non-volatile memory such as a NAND flash memory suitable for miniaturization and large capacity. Therefore, a reduction in the non-volatile storage area leads to lowered performance of the memory system 51.

In recent years, defects of the non-volatile storage area itself have increased in number due to more detailed processes of the non-volatile storage area, and the available non-volatile storage area 53 in the memory system 51 has been reducing. Therefore, the controller 52 cannot exhibit sufficient performance in some cases.

Thus, it is desired to reduce the consumption of the non-volatile storage area 53 to maintain or ensure that the controller 52 can exhibit sufficient functions.

Meanwhile, in order to utilize a recording area not managed by a predetermined file system, Japanese Patent Application Laid-Open Publication No. 2005-339628 discloses an apparatus and a method that back up a directory if there is a capacity for backing up the directory in the recording area and that do not back up the directory if there is no capacity.

Japanese Patent Application Laid-Open Publication No. 2005-339628 discloses a method trying to back up the directory as much as possible, but not improving or eliminating the situation in which the controller 52 cannot exhibit sufficient performance due to the problem described above, i.e., a reduction or consumption of the non-volatile storage area 53.

The present invention has been made in view of the above problems, and the object of the present invention is to provide a memory device and a file system capable of controlling consumption of a non-volatile storage area and of handling reading/writing data from a host device that manages files using multiplexed file management information.

### DISCLOSURE OF INVENTION

### Means for Solving the Problem

A memory device according to an embodiment of the present invention includes: a non-volatile memory including a non-volatile storage area that rewritably stores data; and a controller that controls to read/write data to and from the non-volatile storage area; wherein in response to an instruction to read and write data from an external host device managed by a file system that generates multiplexed file management information so as to include backup information, the controller includes a file management information controlling section that performs a control corresponding to the reading/writing of the data based on file management information that does not include the backup information generated in the non-volatile storage area.

A file system according to an embodiment of the present invention includes: a memory device including a non-volatile memory having a non-volatile storage area that rewritably stores data and a controller that controls to read/write data to and from the non-volatile storage area; and a host device including a host memory in which file management information multiplexed so as to include backup information is generated in a storage area and a host controller that controls to read/write data to and from the memory device; wherein the controller includes a file management information controlling section that performs a control corresponding to the reading/writing of the data based on file management information that does not include the backup information generated in the non-volatile storage area in response to an instruction to read/write data from the host device.

### BRIEF DESCRIPTION OF THE DRAWINGS

FIG. 1 is a block diagram showing a configuration of a memory system being added to a host device according to an embodiment of the present invention;

FIG. 2 is an explanatory view of an operation in case of a first configuration example of the memory system according to an embodiment;

FIG. 3 is an explanatory view of an operation in case of a second configuration example of the memory system according to an embodiment;

FIG. 4 is an explanatory view of an operation in case of a third configuration example of the memory system according to an embodiment;

FIG. 5 is a flow chart showing an operation when an error correction code is added to write data and perform other operations;

FIG. 6 is a diagram showing a configuration of a memory system of a conventional example; and

FIG. 7 is a diagram showing an outline of management of the memory system by a FAT file system of the conventional example.

### BEST MODE FOR CARRYING OUT THE INVENTION

Embodiments of the present invention will now be described with reference to the drawings.

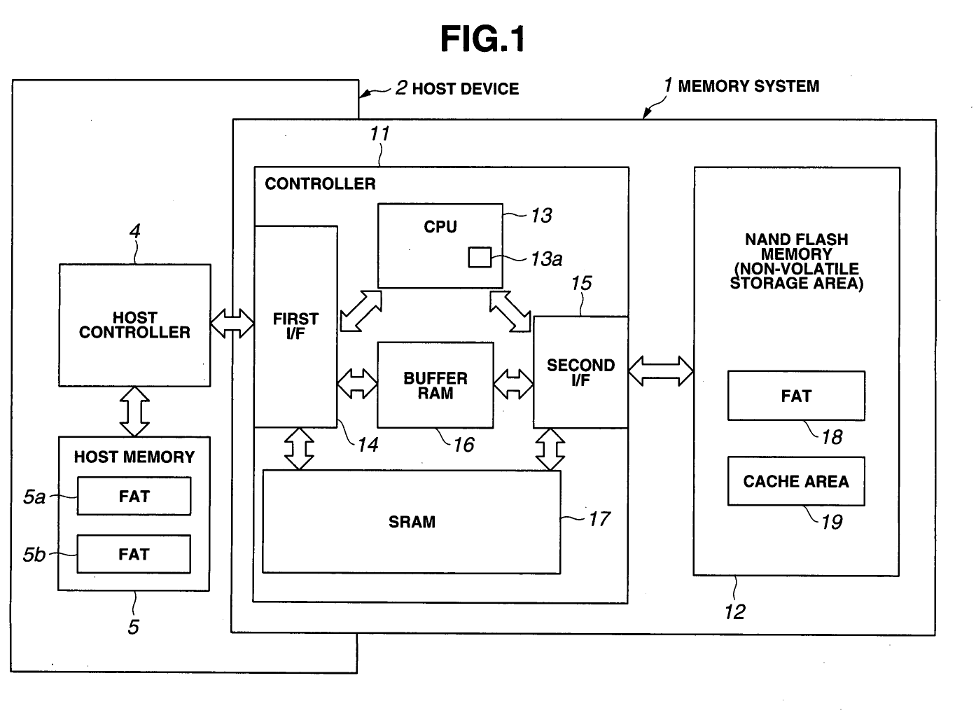

FIG. 1 depicts a configuration example in which a memory system 1 employed in a memory device according to a first embodiment of present invention is added to a host device 2.

As a file management system for managing data of the memory system 1 as a file, the host device 2 employs, for example, a FAT file system, in which a FAT (file allocation table) is used as file management information.

The host device 2 constituted by a digital camera, a personal computer, and the like includes a host controller 4 that uses the FAT file system to manage the memory system 1 and, for example, a host memory 5 as a file information storage that stores the file management information or the like for managing the memory system 1. The file information storage may be constituted not by the host memory 5, but by a hard disk drive or the like.

As described, in the FAT file system, the host controller 4 of the host device 2 forms a host-side first FAT 5a and a host-side second FAT 5b as backup (copy) information of the host-side first FAT 5a in the host memory 5 as multiplexed file management information to manage the memory system 1. Hereinafter, the host-side first FAT 5a is simply abbreviated as FAT 5a (the host-side second FAT 5b is also abbreviated in a similar way).

Although FIG. 1 illustrates a case of duplication, due to the specifications of the FAT file system, a host-side third FAT and the like may be formed on the host memory 5 to implement triplication or further multiplexing.

Meanwhile, the memory system 1 managed (controlled) by the host device 2 using the FAT file system includes a controller 11 that communicates with the host controller 4 with a predetermined protocol and, for example, a NAND flash memory 12 that forms a non-volatile storage area capable of reading/writing (or referring/writing) data under the control of the controller 11.

Employing the NAND flash memory 12 as a non-volatile memory forming the non-volatile storage area is advantageous in that the storage capacity can be made larger with a small size as compared to the case of a NOR flash memory.

The controller 11 includes a CPU 13 that controls the components in the controller 11 and controls to read/write data to and from the NAND flash memory 12.

The controller 11 includes a first interface (abbreviated first I/F) 14 that is electrically connected to the host controller 4 to enable communication, a second interface (abbreviated second I/F) 15 that is electrically connected to the NAND flash memory 12 to transfer data, a buffer RAM 16 that temporarily stores data, and a SRAM 17 as a memory used for error correction and the like.

The SRAM 17 can be used by the CPU 13 when data is transmitted to and received from the host controller 4 and can also be used when reading/writing data to and from the NAND flash memory 12.

In the present embodiment, the host device 2 uses a FAT file system that multiplexes and manages file management information. The memory system 1 includes a FAT 18 as file management information that does not include (is not multiplexed) backup information in the NAND flash memory 12.

The CPU 13 of the controller 11 includes a function of a file management information controlling section 13a that controls to handle reading/writing of data from the host device 2 by the FAT 18 as file management information that is not multiplexed or that does not include backup information as described above.

Generating the FAT 18 as file management information that does not include backup information prevents the storage area of the NAND flash memory 12 forming a non-volatile storage area from being consumed due to multiplexing (backup information) and effectively prevents a reduction in the storage area of the NAND flash memory 12.

Therefore, the CPU 13 controls the reading/writing handling by using the FAT 18 that does not include the backup information when receiving an instruction related to reading/writing of data to and from the NAND flash memory 12 from the host controller 4. A program for reading/writing handling is stored, for example, in a ROM not shown in the CPU 13. The program may also be stored, for example, in the NAND flash memory 12.

As the memory system 1 is added to the host device 2 and power is supplied from the host device 2, the CPU 13 loads a program of the ROM and performs a control operation in accordance with the program.

In the present embodiment, a cache area 19 is formed in a predetermined storage area in the NAND flash memory 12, thereby allowing fast handling of, particularly, a data rewriting process.

A plurality of configuration examples can be considered for reading/writing handling, by the FAT 18 as file management information that is not multiplexed, in response to an instruction to read/write data from the host device 2 managed by the FAT 5a and the FAT 5b as multiplexed file management information that includes backup information.

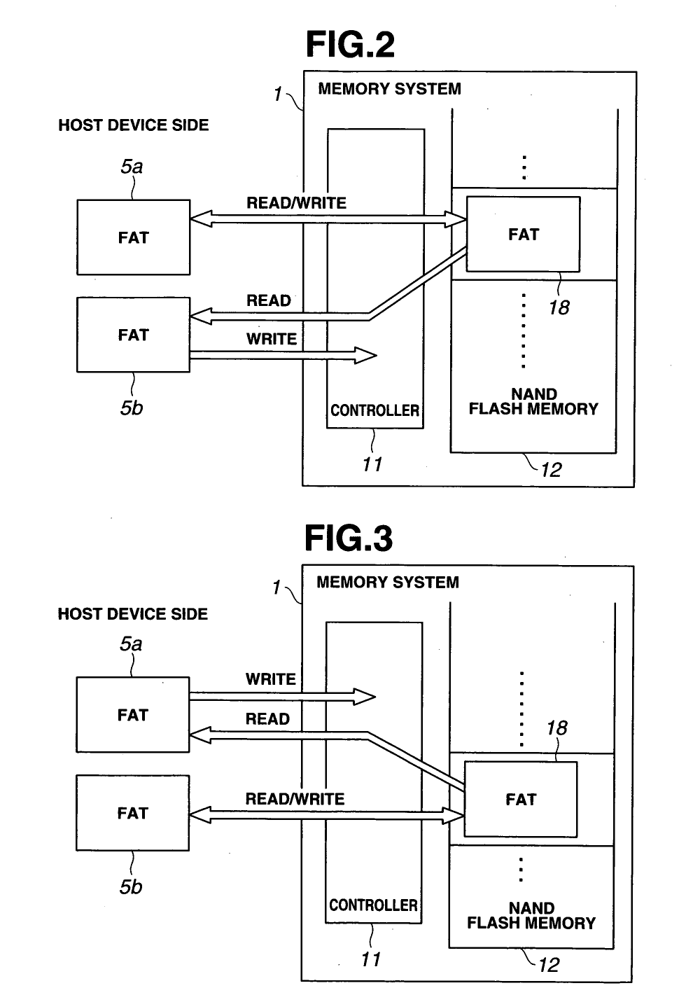

In a first configuration example, the CPU 13 associates the FAT 18 only to the FAT 5a to handle an instruction to read/write data from the host device 2. FIG. 2 depicts an outline of an operation of reading/writing data from the host device 2 in the memory system 1 of the first configuration example.

As shown in FIG. 2, the host device 2 generates the FAT 5a and the FAT 5b multiplexed for managing a file of the memory system 1. Meanwhile, the memory system 1 generates the FAT 18 that does not include the backup information in the NAND flash memory 12 as a non-volatile storage area of the memory system 1.

An instruction to read/write data to and from the memory system 1 is generated from the host device 2 as the user uses, for example, a digital camera as the host device 2.

The controller 11 (CPU 13 actually) of the memory system 1 performs, for example, a control operation, i.e. reading/writing, in which the FAT 18 is associated only to the FAT 5a as shown with a thick arrow of FIG. 2 in response to the instruction to read/write data corresponding to the FAT 5a and the FAT 5b as backup information of the FAT 5a from the host device 2.

On the other hand, in response to an instruction to read corresponding to the FAT 5b, the controller 11 returns the file management information of the FAT 18 as shown with a thick arrow in FIG. 2 and does not execute the write operation to an instruction to write (ignore the instruction to write).

More specifically, the controller 11, upon receiving an instruction to write data related to the FAT 5a from the host device 2, writes the data instructed by the NAND flash memory 12. If the data is the file management information of a file, the controller 11 writes the file management information part of the FAT 18, and the content of the FAT 18 is changed.

Similarly, in response to an instruction to read data of the FAT 5a from the host device 2, the controller 11 reads the instructed data from the NAND flash memory 12.

In this case, the controller 11 reads (refers) the file management information of the FAT 18 if the data instructed for reading is the file management information stored in the FAT 18. The controller 11 then transmits the read data to the host device 2.

The host device 2 updates the file management information of the FAT 5a if the file management information transmitted from the controller 11 is different from the previous one of the FAT 5a.

In response to an instruction to read data related to the FAT 5b as the backup information of the FAT 5a from the host device 2, the controller 11 reads the instructed data in a similar way as with the FAT 5a. The controller 11 then transmits the read information to the host device 2.

In response to an instruction to write data related to the FAT 5b from the host device 2, the controller 11 does not control to write the data.

As described, the controller 11 of the memory system 1 uses the multiplexed file management information to handle reading/writing of data from the host device 2 that manages a file. As a result of the reading/writing handling, the memory system 1 does not generate multiplexed file management information as does the host device 2. The memory system 1 generates file management information that does not include backup information.

Reading/writing data from the host device 2 is handled with the file management information. Therefore, consumption of the non-volatile storage area due to the multiplexing can be effectively controlled, and a reduction in the non-volatile storage area due to the multiplexing can be effectively prevented.

A faster process than when the information is multiplexed is possible because the throughput corresponding to the instruction from the host device 2 can be reduced.

In a second configuration example, the CPU 13 associates the FAT 18 only to the FAT 5b to handle an instruction to read/write data from the host device 2. FIG. 3 depicts an outline of an operation of reading/writing data from the host device 2 in the memory system 1 of the second configuration example.

The operation of FIG. 3 is equivalent to an operation in which the FAT 5a and the FAT 5b are switched in the operation of FIG. 2. Therefore, the description of the operation will be omitted.

The advantages in this case are similar to those in the first configuration example.

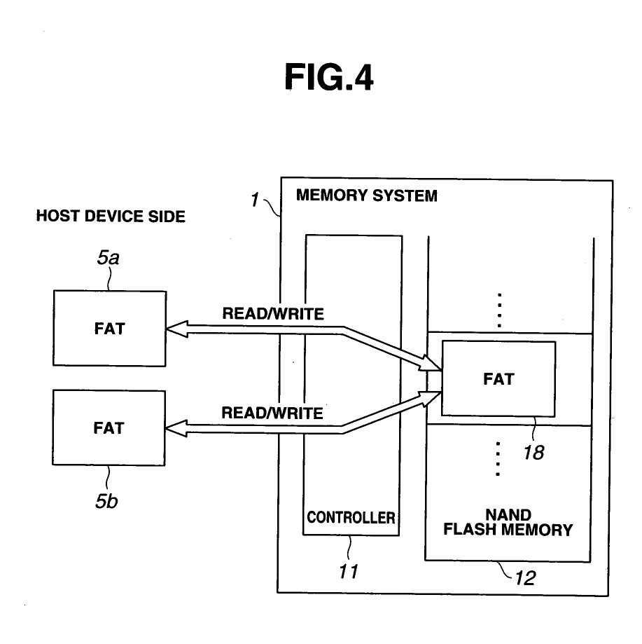

In a third configuration example, the CPU 13 associates the FAT 18 to both of the FAT 5a and the FAT 5b to handle an instruction to read/write data from the host device 2. FIG. 4 depicts an outline of an operation of reading/writing data from the host device 2 in the memory system 1 of the third configuration example.

In this case, in response to an instruction to read/write data related to the FAT 5a from the host device 2, the CPU 13 reads/writes with the FAT 18 in accordance with the instruction.

Similarly, in response to an instruction to read/write data related to the FAT 5b from the host device 2, the CPU 13 reads/writes with the FAT 18 in accordance with the instruction.

This case can also reduce the consumption of the non-volatile storage area due to the multiplexing. In this case, the file management information instructed from the host device 2 most recently can be stored.

In the above embodiment, while the host device 2 side manages files using multiplexed file management information, the controller 11 of the memory system 1 side cancels the multiplexing to manage files with file management information that does not include the backup information. Therefore, the files may be managed by adding an error correction code (ECC) as described below.

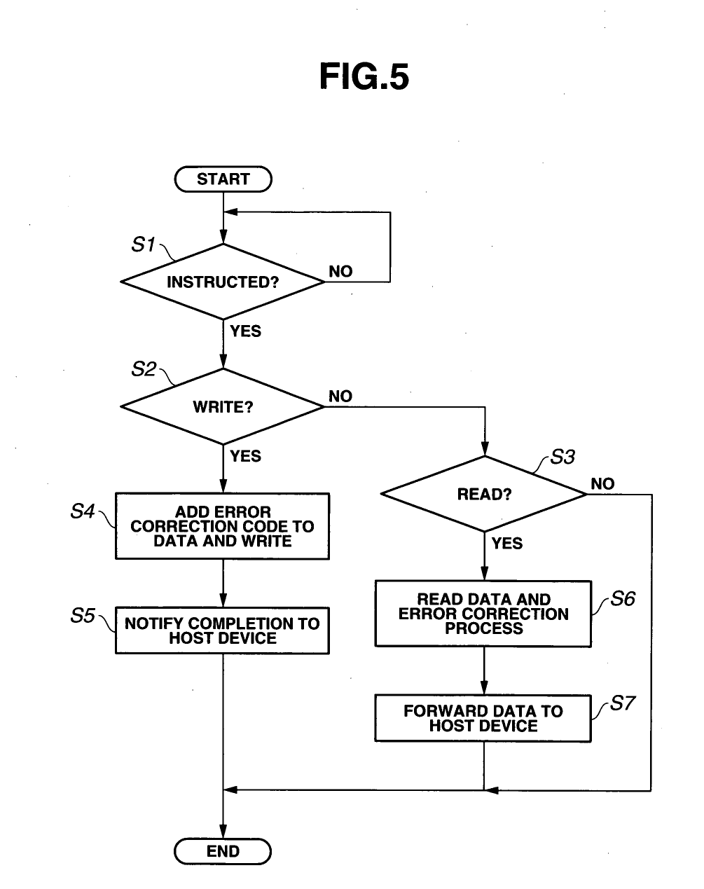

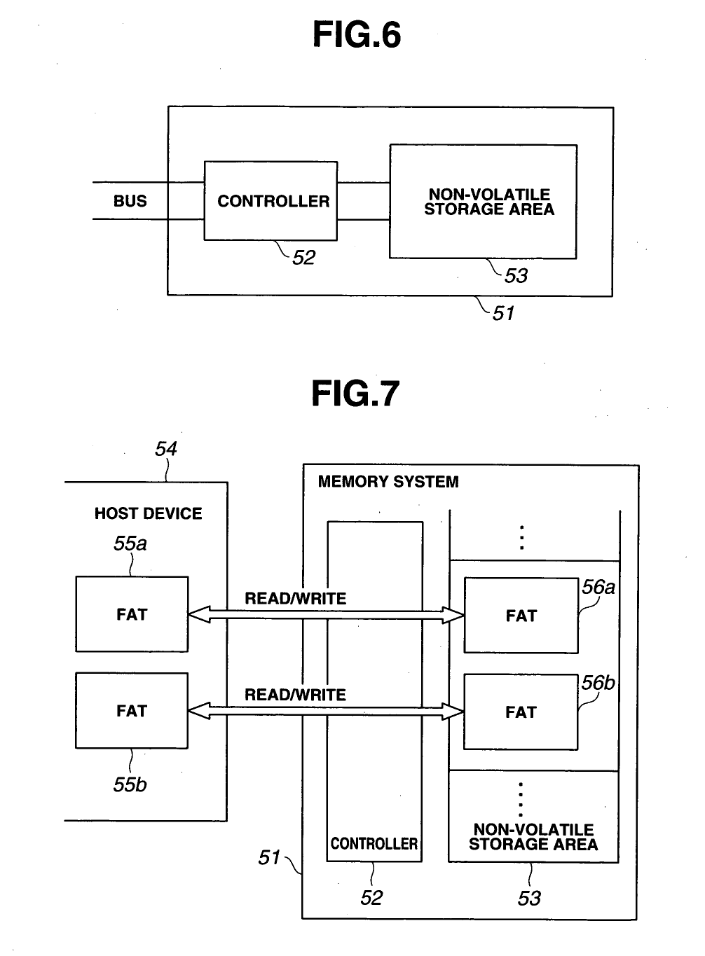

FIG. 5 is a flow chart of an operation when the files are managed by adding an error correction code in, for example, the third configuration. The following case describes writing of data by adding an error correction code to the FAT data as the file management information of the FAT 18 as well as to the data of the data area.

In the first step S1, the CPU 13 of the controller 11 waits for an instruction from the host controller 4.

The CPU 13, upon receiving an instruction from the host controller 4, determines whether the instruction is to write data as shown in step S2 or to read data as shown in step S3.

When determining that the instruction is to write data in the determination of step S2, the CPU 13 adds an error correction code to the instructed data as shown in step S4 and writes the data into the NAND flash memory 12.

If the instructed data is the FAT data as file management information to be written in the FAT 18, the CPU 13 adds an error correction code to the FAT data to write the FAT data.

If the instructed data is the data of the data area instead of the FAT data, the CPU 13 adds an error correction code to the data to write the data and adds an error correction code to the FAT data corresponding to the data to write the FAT data (as a modified example, an error correction code may be added in case of the FAT data only).

As shown in step S5, the CPU 13 then notifies the completion of the writing operation to the host controller 4 of the host device 2 and ends the writing process.

On the other hand, when determining that the instruction is not writing in the determination of step S2, the CPU 13 determines whether the instruction is to read data in step S3. When determining that the instruction is to read data, the CPU 13 reads the data and corrects an error as shown in step S6. As shown in step S7, the CPU 13 transmits the data to the host controller 4 of the host device 2 and ends the reading process.

The process of FIG. 5 ends if it is determined that the instruction is not to read in the determination process of step S3.

Managing files as shown in FIG. 5 enables to ensure the reliability by adding an error correction code even when the files are managed by the FAT 18 without multiplexing. In this case, more storage area is consumed by adding the error correction code than when the error correction code is not added. However, as compared to the amount of data in case of multiplexing, the consumption can be significantly reduced.

The process of FIG. 5 may also be applied to the first configuration or the second configuration.

The user may be able to select and set an error correction function and correction ability when adding an error correction code.

High-speed data rewriting can be achieved without deleting blocks upon rewriting the data if writing of data that needs to be rewritten is handled using the cache area 19.

Although the host device 2 employing the FAT file system has been described in the above description, an example of a file system in which the host device 2 multiplexes and manages files is not limited to this.

The present embodiment can also be applied to a file system such as an NTFS (New Technology File System) and an Ext (Second Extended File System).

### INDUSTRIAL APPLICABILITY

The present invention is applied to the file management of a memory device connected to a host device such as a digital camera and a personal computer through an interface.

The present application is for applying Japanese Patent Application No. 2007-231819 applied in Japan on Sep. 6, 2007 as the basis of the claim of priority, and the contents of disclosure are quoted in the present application and the claims.

1. A memory device comprising:
a non-volatile memory including a non-volatile storage area that rewritably stores data; and
a controller that controls to read/write data to and from the non-volatile storage area, wherein
in response to an instruction to read and write data from an external host device managed by a file system that generates multiplexed file management information so as to include backup information,
the controller comprises a file management information controlling section that performs a control corresponding to the reading/writing of data based on file management information that does not include the backup information generated in the non-volatile storage area.

2. The memory device according to claim 1, wherein
if the multiplexed file management information is formed of first file management information and second file management information as backup information of the first file management information, the file management information controlling section generates file management information that does not include the backup information in the non-volatile storage area in association with only the first file management information and controls reading/writing of file management information that does not include the backup information only when reading/writing of data from the host device corresponds to the first file management information.

3. The memory device according to claim 2, wherein
the file management information controlling section reads data of the file management information that does not include the backup information if an instruction to read data from the host device corresponds to the second file management information
and controls to substantially do nothing if an instruction to write data from the host device corresponds to the second file management information.

4. The memory device according to claim 1, wherein
the controller adds an error correction code and writes data to the non-volatile storage area in response to the instruction to write data.

5. The memory device according to claim 4, wherein
the controller adds an error correction code and writes data to the non-volatile storage area if the data is an instruction to write file management information.

6. The memory device according to claim 1, wherein
the non-volatile memory is formed of a NAND flash memory.

7. The memory device according to claim 2, wherein
the controller adds an error correction code and writes data to the non-volatile storage area in response to the instruction to write data.

8. The memory device according to claim 2, wherein
the non-volatile memory is formed of a NAND flash memory.

9. The memory device according to claim 3, wherein
the controller adds an error correction code and writes data to the non-volatile storage area in response to the instruction to write data.

10. The memory device according to claim 3, wherein
the non-volatile memory is formed of a NAND flash memory.

11. A file system comprising:
a memory device comprising a non-volatile memory including a non-volatile storage area that rewritably stores data and a controller that controls to read/write data to and from the non-volatile storage area; and
a host device comprising a host memory in which file management information multiplexed so as to include backup information is generated in a storage area and a host controller that controls to read/write data to and from the memory device, wherein
the controller comprises a file management information controlling section that performs a control corresponding to the reading/writing of the data based on file management information that does not include the backup information generated in the non-volatile storage area in response to an instruction to read/write data from the host device.

12. The file system according to claim 11, wherein
if the multiplexed file management information generated on the host memory is formed of first file management information and second file management information as backup information of the first file management information, the file management information controlling section generates file management information that does not include the backup information in the non-volatile storage area in association with only the first file management information and controls reading/writing of file management information that does not include the backup information only when reading/writing of data from the host device corresponds to the first file management information.

13. The file system according to claim 12, wherein
the file management information controlling section reads data of the file management information that does not include the backup information if an instruction to read data from the host device corresponds to the second file management information
and controls to substantially do nothing if an instruction to write data from the host device corresponds to the second file management information.

14. The file system according to claim 11, wherein
the controller adds an error correction code and writes data to the non-volatile storage area in response to the instruction to write data.

15. The file system according to claim 11, wherein
the non-volatile memory is formed of a NAND flash memory.

16. A file system comprising:
a memory device comprising a non-volatile memory having a non-volatile storage area that rewritably stores data and a controller that controls to read/write data to and from the non-volatile storage area; and
a host device comprising a host memory including a storage area that rewritably stores data and a host controller that controls to read/write data to and from the memory device, wherein
a plurality of pieces of file management information multiplexed so as to include backup information are generated in the storage area, a piece of file management information that does not include backup information is generated in the non-volatile storage area, and the controller comprises a file management information controlling section that performs a control corresponding to the reading/writing of data based on file management information generated in the non-volatile storage area in response to an instruction to read/write data from the host device.

17. The file system according to claim 16, wherein
if the multiplexed file management information generated in the host memory is formed of first file management information and second file management information as backup information of the first file management information, the file management information controlling section generates file management information that does not include the backup information in the non-volatile storage area in association with only the first file management information and controls reading/writing of file management information that does not include the backup information only when reading/writing of data from the host device corresponds to the first file management information.

18. The file system according to claim 17, wherein
the file management information controlling section reads data of the file management information that does not include the backup information if an instruction to read data from the host device corresponds to the second file management information
and controls to substantially do nothing if an instruction to write data from the host device corresponds to the second file management information.

19. The file system according to claim 16, wherein
the controller adds an error correction code and writes data to the non-volatile storage area in response to the instruction to write data.

20. The file system according to claim 16, wherein
the non-volatile memory is formed of a NAND flash memory.
